(19) United States
(12) Patent Application Publication
(10) Pub. No.: US 2019/0292368 A1
(43) Pub. Date: Sep. 26, 2019

(54) LIQUID SILICONE RUBBER COMPOSITION, METHOD FOR MANUFACTURING THEREOF, AND ORAL ISOLATOR MANUFACTURED USING THE SAME

(71) Applicant: MEGAFORCE COMPANY LIMITED, New Taipei City (TW)

(72) Inventors: Jiun-Ruei Li, NEW TAIPEI CITY (TW); Guo-Bing Xie, NEW TAIPEI CITY (TW); Shun-Feng Huang, NEW TAIPEI CITY (TW)

(21) Appl. No.: 16/137,916

(22) Filed: Sep. 21, 2018

(30) Foreign Application Priority Data
Mar. 23, 2018 (CN) 201810246712.X

(51) Int. Cl. C08L 83/04; A61C 5/90; C08K 3/36

(52) U.S. Cl. CPC C08L 83/04; A61C 5/90; C08K 3/36; C08K 2201/009; C08L 2203/02; C08K 2201/005; C08L 2205/025

(57) ABSTRACT

A method for manufacturing a liquid silicone rubber composition including a preparation step, a mixing step, an introduction step, and a curing step. The preparation step includes providing at least a first gel and a second gel. The mixing step includes mixing the first gel and the second gel to form a mixed gel. The introduction step includes introducing the mixed gel into a mold. The curing step includes heating up the mold to cure the mixed gel to form a liquid silicone rubber composition.

### CROSS-REFERENCE TO RELATED APPLICATION

This non-provisional application claims priority under 35 U.S.C. § 119(a) to Patent Application No. 201810246712.X filed in China, P.R.C. on Mar. 23, 2018, the entire contents of which are hereby incorporated by reference.

### BACKGROUND

### Technical Field

The instant disclosure generally relates to a liquid silicone rubber composition and, more particularly, to a liquid silicone rubber composition suitable for manufacturing medical aids.

### Related Art

Polymeric materials have been commonly used in medical aids, such as oral isolators used by dentists, which requires excellent light guiding properties to facilitate dentists to operate and perform medical treatment in a patient's mouth.

Polymeric materials such as rubber, which is generally used as an oral isolator, are thermoplastic elastomers and exhibit low transparency because they may yellow due to long-term use. In addition, oral isolators made of these materials have a shrinkage point and a bonding line due to injection molding, which impairs appearance. Consequently, a fluorescent agent is usually added to improve the appearance, but the addition of the fluorescent agent is inhibits illumination and light guiding in the mouth.

There are also oral isolators manufactured of solid-state silicone rubber compositions. Oral isolators used for oral treatment are provided with occlusion portions for the occlusion of different patients. The occlusal force of each patient is different. To facilitate comfortable occlusion for the patients, the structure of an oral isolator is complex and sophisticated. However, an oral isolator made of a solid-state silicone rubber composition exhibits poor precision, low yield, and insufficient light guiding, which does not facilitate oral treatment.

Consequently, there is a need for developing a material applicable to the making of an oral isolator with good precision, simple manufacture, and excellent light guiding properties.

### SUMMARY

In view of this, in one embodiment, the instant disclosure provides a liquid silicone rubber composition applicable to the making of an oral isolator, including vinyl-terminated polydimethylsiloxane (PDMS) accounting for 39 wt % to 62.5 wt % of the liquid silicone rubber composition, silicon dioxide accounting for 25 wt % to 30 wt % of the liquid silicone rubber composition, polymethylhydrogensiloxane (PMHS) accounting for 4.5 wt % to 17.5 wt % of the liquid silicone rubber composition, and a catalyst accounting for 0.1 wt % to 1 wt % of the liquid silicone rubber composition.

In one embodiment, the liquid silicone rubber composition further includes a plurality of light diffusing particles accounting for 0.2 wt % to 5.0 wt % of the liquid silicone rubber composition.

In one embodiment, the particle size of the plurality of light diffusing particles is within a range of 0.1 μm to 10 μm.

In one embodiment, the Shore A hardness is within a range of 30 to 60.

In one embodiment, the light transmittance of the liquid silicone rubber composition is within a range of 85% to 90%.

In one embodiment, the instant disclosure further provides an oral isolator manufactured of a liquid silicone rubber composition as described above.

In one embodiment, the light transmittance of the oral isolator is within a range of 80% to 90% when the thickness of the oral isolator is 3.0 mm.

In one embodiment, the instant disclosure further provides a method for manufacturing a liquid silicone rubber composition, including: performing a preparation step to at least provide a first gel and a second gel, wherein the first gel includes vinyl-terminated polydimethylsiloxane (PDMS) accounting for 30 wt % to 45 wt % of the first gel, silicon dioxide accounting for 25 wt % to 30 wt % of the first gel, and polymethylhydrogensiloxane accounting for 5 wt % to 25 wt % of the first gel, and the second gel includes vinyl-terminated polydimethylsiloxane accounting for 60 wt % to 70 wt % of the second gel, silicon dioxide accounting for 25 wt % to 30 wt % of the second gel and a catalyst accounting for 0.1 wt % to 1 wt % of the second gel; performing a mixing step to mix the first gel and the second gel to form a mixed gel, the ratio of the first gel to the second gel being within a range of 30:70 to 70:30; performing an introduction step to introduce the mixed gel into a mold; and performing a curing step to heat up and cure the mixed gel to form the liquid silicone rubber composition. In one embodiment, the liquid silicone rubber composition is an oral isolator.

In one embodiment, in the curing step, the temperature of the mold is within a range of 140° C. to 170° C.

In one embodiment, in the preparation step, the first gel further includes a light diffusing agent accounting for 0.1 wt % to 2.5 wt % of the first gel, and the second gel further includes the light diffusing agent accounting for 0.1 wt % to 2.5 wt % of the second gel.

In one embodiment, the light diffusing agent includes a plurality of diffusing particles, the particle size of the plurality of light diffusing particles being within a range of 0.1 μm to 10 μm.

The liquid silicone rubber composition according to one embodiment of the instant disclosure exhibits excellent light guiding properties to uniformly transmit light to the entire liquid silicone rubber composition as an oral isolator to facilitate illumination in the mouth. In another embodiment, a liquid silicone rubber composition includes a plurality of light diffusing particles to diffuse light in random directions. Due to reflection and refraction, light received by the liquid silicone rubber composition is diverged from various angles to facilitate light guiding and enhance light illuminance.

The method for manufacturing a liquid silicone rubber composition according to one embodiment of the instant utilizes addition-type liquid silicone rubber, which is better than condensation-type liquid silicone rubber because it does not produce by-products during cross-linking vulcanization, unlike condensation-type liquid silicone rubber. Moreover, addition-type liquid silicone rubber exhibits high cross-linking conversion rate during vulcanization without needing a large amount of catalyst. In addition, the shrinkage rate of addition-type liquid silicone rubber is small such that the surface and the interior thereof can be vulcanized uniformly to result in uniform size and the linear shrinkage rate being within a range of 0 to 0.2%. The physical properties of addition-type liquid silicone rubber after vulcanization surpass millable rubber.

In other words, in one embodiment of the instant disclosure, addition-type liquid silicone rubber is used. Addition-type liquid silicone rubber is non-corrosive, environmentally friendly, and applicable to injection molding or compression molding to achieve simple processing, high production efficiency, low manufacturing cost and energy saving. The manufactured liquid silicone rubber composition is easy to demould. The processed product has a certain hardness, high transparency, high biocompatibility, and is harmless to the human body. Consequently, it is suitable for the making of an oral isolator.

### BRIEF DESCRIPTION OF THE DRAWINGS

This disclosure will become more fully understood from the detailed description given herein below for illustration only, and thus not limitative of this disclosure, wherein:

FIG. 1 is a flowchart of a method for manufacturing a liquid silicone rubber composition according to one embodiment of the instant disclosure;

FIG. 2 is a flowchart of a method for manufacturing a liquid silicone rubber composition according to another embodiment of the instant disclosure; and

FIG. 3A to FIG. 3C illustrate light diffusion patterns result from light diffusion tests on a liquid silicone rubber composition according to a third embodiment of the instant disclosure.

### DETAILED DESCRIPTION

The instant disclosure provides a liquid silicone rubber composition applicable to the making of an oral isolator. In one embodiment, the liquid silicone rubber composition includes vinyl-terminated polydimethylsiloxane (PDMS) accounting for 39 wt % to 62.5 wt % of the liquid silicone rubber composition, silicon dioxide accounting for 25 wt % to 30 wt % of the liquid silicone rubber composition, polymethylhydrogensiloxane (PMHS) accounting for 4.5 wt % to 17.5 wt % of the liquid silicone rubber composition, and a catalyst accounting for 0.1 wt % to 1 wt % of the liquid silicone rubber composition.

In one embodiment, the above-mentioned silicon dioxide may refer to gas-phase silicon dioxide. Gas-phase silicon dioxide (fumed silica) has a very small particle size such that it has a large surface area, strong surface adsorbability, high surface energy, high chemical purity, good dispersion performance, specific thermal resistance, electric resistance, and other useful properties. Consequently, it is often used as premium filler for dental materials.

In one embodiment, the above-mentioned catalyst is a platinum catalyst.

In one embodiment, the liquid silicone rubber composition further includes a plurality of light diffusing particles accounting for 0.2 wt % to 5.0 wt %. These light diffusing particles change the directions in which light travels. Due to reflection and refraction, the liquid silicone rubber composition can receive diverged light from more angles to facilitate light transmission.

The light diffusing particles may be organic silicon, polymethyl methacrylate (PMMA) or transparent copolymer such as methyl methacrylate-styrene (MS) resin synthesized by mixing methyl methacrylate (MMA) and styrene monomer (SM). In some embodiments, the light diffusing particles are high-reflectance and transparent, for example, glass microspheres, glass micropowders, mica flake powders, phosphor powders or reflective oxide films.

In some embodiments, the particle size of the light diffusing particles is within a range of 0.1 μm to 10 μm.

In one embodiment, the Shore A hardness of the liquid silicone rubber composition is within a range of 30 to 60, such that it can be applied to dental and oral medicine for patient occlusion.

In one embodiment, when the thickness of the liquid silicone rubber composition is 1.25 mm, light transmittance is within a range of 85% to 90%. In cases where light transmittance is high, the light can be diverged evenly to enhance the illumination.

As mentioned previously, since the liquid silicone rubber composition includes light diffusing particles and has good light guiding properties, illumination in the mouth can be improved. The Shore A hardness of the liquid silicone rubber composition is, in some embodiments, within a range of 30 to 60, so the hardness makes the liquid silicone rubber composition suitable for oral occlusion of patients, while being not easily damaged. Therefore, the liquid silicone rubber composition according to one embodiment of the instant disclosure is suitable for the making of an oral isolator. In one embodiment, when the thickness of the entire oral isolator or a partial portion of the oral isolator is 3.0 mm, light transmittance is within a range of 80% to 90%.

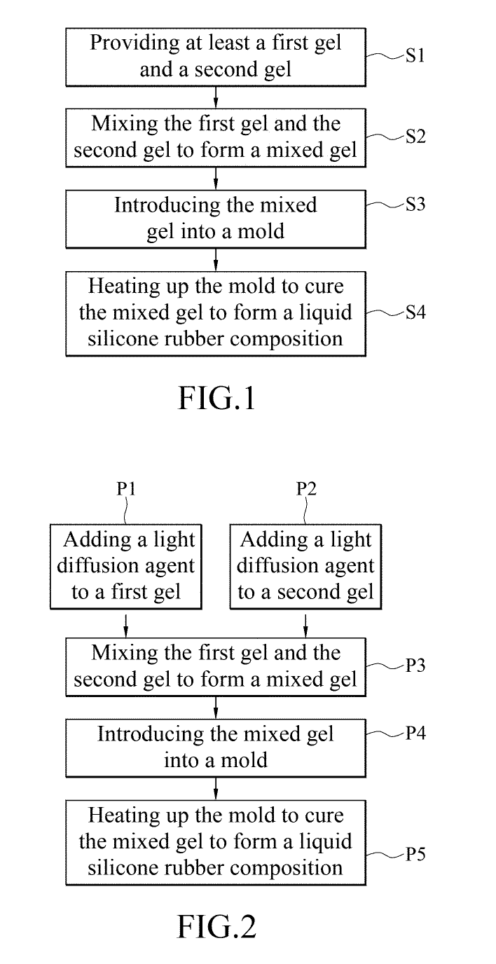

Please refer to FIG. 1, in which a flowchart of a method for manufacturing a liquid silicone rubber composition according to one embodiment of the instant disclosure is shown. The method includes a preparation step, a mixing step, an introduction step and a curing step.

In the preparation step (Step S1), at least a first gel and a second gel are provided. The first gel includes first vinyl-terminated polydimethylsiloxane (PDMS) accounting for 30 wt % to 45 wt % of the first gel, first silicon dioxide accounting for 25 wt % to 30 wt % of the first gel, and polymethylhydrogensiloxane accounting for 5 wt % to 25 wt % of the first gel. The second gel includes second vinyl-terminated polydimethylsiloxane accounting for 60 wt % to 70 wt % of the second gel, second silicon dioxide accounting for 25 wt % to 30 wt % of the second gel and a catalyst accounting for 0.1 wt % to 1 wt % of the second gel.

In the mixing step (Step S2), the first gel and the second gel are mixed at room temperature to form a mixed gel. In other words, in one embodiment of the instant disclosure, the possibility of adding other gel is not excluded. In the mixing step (Step S2), the gels (including the first gel, the second gel, and one or more other gels) are mixed uniformly.

In this embodiment, the weight ratio of the first gel to the second gel is within a range of 30:70 to 70:30 under a mixing pressure ratio of 1:1.

In the introduction step (Step S3), the mixed gel is introduced into a mold. In one embodiment, the introduction is by injection molding with an injection time within a range of 4 seconds to 6 seconds. The mold can be a mold of an oral isolator.

In the curing step (Step S4), the mold is heated up to cure the mixed gel to form a liquid silicone rubber composition. In one embodiment, the heat-up time is within a range of 40 seconds to 50 seconds. The mold temperature is within a range of 150 degrees (° C.) to 170 degrees (° C.).

In the first embodiment, the viscosity of the first gel is within a range of 530 to 540 Pa·S (kg·m⁻¹·s⁻¹), and the viscosity of the second gel is within a range of 550 to 560 Pa·S (kg·m⁻¹·s⁻¹). In the introduction step (Step S3), the mixed gel is injected into the mold at the time of 4.5 seconds. In the curing step (Step S4), the heat-up time is 50 seconds and the temperature of the heated mold is 158 degrees (° C.). Then, the liquid silicone rubber composition is taken out of the mold and placed on a cutting die to be punched to obtain a finished product. Here, the Shore A hardness of the obtained liquid silicone rubber composition is 30.

In the second embodiment, the viscosity of the first gel is within a range of 710 to 720 Pa·S (kg·m⁻¹·s⁻¹), the viscosity of the second gel is within a range of 635 to 645 Pa·S (kg·m⁻¹·s⁻¹). In the introduction step (Step S3), the mixed gel is injected into the mold at the time of 4.5 seconds. In the curing step (Step S4), the heat-up time is 45 seconds and the temperature of the heated mold is 158 degrees (° C.). Then, the liquid silicone rubber composition is taken out of the mold and placed on a cutting die to be punched to obtain a finished product. Here, the Shore A hardness of the obtained liquid silicone rubber composition is 40.

Please refer to Table 1, in which the light transmittance test on the liquid silicone rubber composition according to the first embodiment and the second embodiment is summarized.

TABLE 1

| | | Test | Blank | Light |
|---|---|---|---|---|
| | Thickness | Value | Value | Transmittance |
| First Embodiment | 1.25 mm | 101.5 | 132.2 | 86.78% |
| Second Embodiment | 1.25 mm | 104.3 | 132.2 | 88.90% |

Blank value: Test data without liquid silicone rubber composition
Test value: Test data with liquid silicone rubber composition

From Table 1, for the liquid silicone rubber composition according to one embodiment of the instant, the light transmittance is within a range of 85% to 90% when the thickness is 1.25 mm.

Please refer to Table 2, in which the yellowing test results of the liquid silicone rubber composition according to the first embodiment and the second embodiment are summarized in a yellowing test table, in which a conventional thermoplastic elastomer (TPE) is used as a reference.

TABLE 2

| | Standard | | | | | | Yellowing |
|---|---|---|---|---|---|---|---|
| | Light Source | L | a | b | DL | Db | Degree |
| First Embodiment | D65 | 89.308 | −0.014 | 4.065 | 0.909 | 0.125 | Transparent |
| | CWF | 89.481 | −0.049 | 46.08 | 0.914 | 0.141 | |
| Second Embodiment | D65 | 89.449 | −0.063 | 4.545 | 1.05 | 0.604 | Transparent |
| | CWF | 89.647 | −0.089 | 5.166 | 1.08 | 0.699 | |
| Second Embodiment | D65 | 88.634 | −0.023 | 5.259 | 0.235 | 1.319 | Transparent, |
| (3-Year Use) | CWF | 88.87 | −0.067 | 5.942 | 0.303 | 1.475 | Yellowish |
| TPE (Phosphor | D65 | 86.567 | −0.582 | 2.975 | −1.833 | −0.965 | Transparent, |
| Powders Added) | CWF | 86.662 | −0.415 | 3.34 | −1.905 | −1.127 | Light Yellow |

Note:
Yellowing Degree is observed visually.
L indicates illumination and darkness.
a indicates red green, and b indicates yellowish blue.
A positive value of DL indicates the brightening degree, and a negative value indicates the darkening degree.
A positive value of Db indicates the yellowing degree, and a negative value indicates the bluing degree.

From Table 2, it can be seen that the liquid silicone rubber composition according to the first embodiment and the second embodiment has higher transparency than a conventional thermoplastic elastomer. Even with three-year use, the yellowing degree is lower than that of the conventional thermoplastic elastomer.

The instant disclosure further provides a method of manufacturing a liquid silicone rubber composition according to one embodiment. Please refer to FIG. 2, in which a flowchart of a method for manufacturing a liquid silicone rubber composition according to another embodiment of the instant disclosure is shown. Different from the method according to the previous one embodiment, in the method according to the present embodiment, the preparation step includes a first preparation step and a second preparation step to add a light diffusing agent accounting for 0.1 wt % to 2.5 wt % to a first gel and add a light diffusing agent accounting for 0.1 wt % to 2.5 wt % to a second gel, and detailed descriptions thereof will be presented as follows.

The method for manufacturing a liquid silicone rubber composition includes a first preparation step, a second preparation step, a mixing step, an introduction step, and a curing step.

In the first preparation step (Step P1), a light diffusing agent is added to a first gel to form a first mixture. The first mixture is stirred at a rotation speed of 1400 revolutions per minute (rpm) at a temperature of 25 degrees (° C.) and is defoamed at a vacuum degree within a range of −750 to −760 torr for 4 hours (Hr).

The light diffusing agent may include organic silicon, polymethyl methacrylate (PMMA) or transparent copolymer such as methyl methacrylate-styrene (MS) resin synthesized by mixing methyl methacrylate (MMA) and styrene monomer (SM). In some embodiments, the light diffusing agent is high-reflectance and transparent, for example, including glass microspheres, glass micropowders, mica flake powders, phosphor powders or transparent and reflective oxide films.

In the second preparation step (Step P2), a light diffusing agent is added to a second gel to form a second mixture. The second mixture is stirred at 1400 revolutions per minute (rpm) at a temperature of 25 degrees (° C.) and is defoamed at a vacuum degree within a range of −750 to −760 torr for 4 hours (Hr).

In the mixing step (Step P3), the first gel and the second gel are mixed at room temperature to form a mixed gel. The weight ratio of the first gel to the second gel is within a range of 30:70 to 70:30 under a mixing pressure ratio of 1:1.

In the introduction step (Step P4), the mixed gel is introduced into a mold. In one embodiment, the introduction is by injection molding with an injection time within a range of 4 seconds to 6 seconds. The mold can be a mold of an oral isolator.

In the curing step (Step P5), the mold is heated up to cure the mixed gel to form a liquid silicone rubber composition. In one embodiment, the heat-up time is within a range of 50 seconds to 70 seconds. The mold temperature is within a range of 140 degrees (° C.) to 160 degrees (° C.).

In one embodiment, the preparation step further includes other preparation steps, which means adding the light diffusing agent to the other one or more gels. In other words, in the mixing step (Step P3), other gels including a light diffusing agent may be mixed with the first gel and the second gel.

Hereinafter, the method for manufacturing a liquid silicone rubber composition according to a third embodiment of the instant disclosure is different from the previous embodiment. In the present embodiment, the first gel and the second gel include a light diffusing agent. From Table 3, the first gel and the second gel in the third embodiment may have different compositions.

TABLE 3

| | First Gel including Light Diffusing Agent | | | | | | |
|---|---|---|---|---|---|---|---|
| Symbol | A0 | A1 | A2 | A3 | A4 | A5 | A6 |
| First Gel | 100 | 99.75 | 99.5 | 99 | 98.5 | 98 | 97.5 |
| Light Diffusing | 0 | 0.25 | 0.5 | 1 | 1.5 | 2 | 2.5 |
| Agent | | | | | | | |
| | Second Gel including Light Diffusing Agent | | | | | | |
| Symbol | B0 | B1 | B2 | B3 | B4 | B5 | B6 |
| Second Gel | 100 | 99.75 | 99.5 | 99 | 98.5 | 98 | 97.5 |
| Light Diffusing | 0 | 0.25 | 0.5 | 1 | 1.5 | 2 | 2.5 |
| Agent | | | | | | | |

Unit: wt %

In the third embodiment, organic silicon powders, for example, silicone powders are used as a light diffusing agent. The particle size of the light diffusing particles is within a range of 0.1 μm to 10 μn.

In the mixing step, the first gel and the second gel are mixed with a weight ratio of 1:1 and stirred uniformly at a rotation speed of 1000 rpm. In the curing step (Step P5), the mold is heated up with the heat-up time of 60 seconds such that the mold temperature is 130 degrees (° C.).

Please refer to Table 4, in which the light transmittance test results of the liquid silicone rubber composition according to the third embodiment are summarized. The wavelength of light is within a range of 400 to 800 nm. The light transmittance test is performed by a spectrometer for visible light. The thickness of the liquid silicone rubber composition is 3 mm.

TABLE 4

| | Liquid Silicone Rubber Composition | | | | | | |
|---|---|---|---|---|---|---|---|
| | A0/B0 | A1/B1 | A2/B2 | A3/B3 | A4/B4 | A5/B5 | A6/B6 |
| Appearance | Transparent | Transparent | Transparent | Transparent | Transparent | Transparent | Transparent |
| Light Transmittance (%) | 85 to 89 | 85 to 89 | 85 to 88 | 84 to 88 | 84 to 88 | 83 to 87 | 83 to 85 |

Please refer to Table 5, in which the astigmatism test results of the liquid silicone rubber composition according to the third embodiment are summarized. The liquid silicone rubber composition is disposed in light source and the receiver, respectively, to observe the power received by the receiver. The initial power is 219 mW, and the distance between the light source and the receiver is 35 cm.

TABLE 5

| | Liquid Silicone Rubber Composition | | | | | | |
|---|---|---|---|---|---|---|---|
| | A0/B0 | A1/B1 | A2/B2 | A3/B3 | A4/B4 | A5/B5 | A6/B6 |
| Received Power (mW) | 124.0 | 119.3 | 118.7 | 116.7 | 110.3 | 107.3 | 99.2 |
| Energy Flux (W/cm²) | 94.3 | 80.3 | 75.2 | 74.7 | 64.5 | 52.7 | 47.3 |

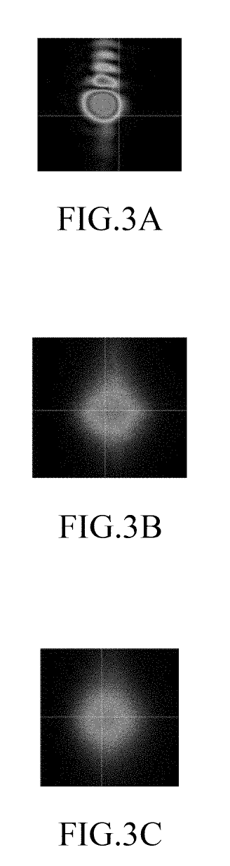

Please refer to FIG. 3A to FIG. 3C, in which light diffusion patterns result from light diffusion tests on the liquid silicone rubber composition according to the third embodiment of the instant disclosure are respectively illustrated. FIG. 3A shows a light diffusion pattern without disposing a liquid silicone rubber composition in the light source and the receiver. FIG. 3B shows a light diffusion pattern of the liquid silicone rubber composition (A0/B0) disposed in the light source and the receiver. FIG. 3C shows a light diffusion pattern of the liquid silicone rubber composition (A6/B6) disposed in the light source and the receiver.

As shown in Table 4, Table 5, and FIG. 3A-3B, it is known that the light transmittance decreases as the amount of added silicone powders increases, while still maintaining high light transmittance.

For the astigmatism test, the received power decreases as the amount of added silicone powders increases, because after the addition of silicone powders, astigmatism occurs while light travels. Therefore, the detected power is reduced. In addition, it can be seen from the energy flux that with the increase of the amount of added silicone powders, the power is less concentrated. In summary, it can be confirmed that silicone powders (light diffusing particles) affect the optical path in silicone and cause scattering.

The liquid silicone rubber composition according to one embodiment of the instant disclosure exhibits excellent light guiding properties to transmit light uniformly to the entire liquid silicone rubber composition as an oral isolator to facilitate illumination in the mouth. In another embodiment, a liquid silicone rubber composition includes a plurality of light diffusing particles to diffuse light in random directions. Due to reflection and refraction, light received by the liquid silicone rubber composition is diverged from various angles to facilitate light guiding and enhance light illuminance.

The method for preparing a liquid silicone rubber composition according to one embodiment of the instant disclosure can be applied to injection molding or compression molding, which is convenient in processing and high in production efficiency, so that the purpose of low cost and energy saving can be achieved. The liquid silicone rubber composition produced can be easily released from the mold. The processed product has a certain hardness and high transparency, and has a high degree of biocompatibility and does not harm the human body. Consequently, it is suitable for making an oral isolator.

What is claimed is:

1. A liquid silicone rubber composition, comprising:
vinyl-terminated polydimethylsiloxane (PDMS) accounting for 39 wt % to 62.5 wt % of said liquid silicone rubber composition;
silicon dioxide accounting for 25 wt % to 30 wt % of said liquid silicone rubber composition;
polymethylhydrogensiloxane (PMHS) accounting for 4.5 wt % to 17.5 wt % of said liquid silicone rubber composition; and
a catalyst accounting for 0.1 wt % to 1 wt % of said liquid silicone rubber composition.

2. The liquid silicone rubber composition according to claim 1, further comprising a plurality of light diffusing particles accounting for 0.2 wt % to 5.0 wt % of said liquid silicone rubber composition.

3. The liquid silicone rubber composition according to claim 2, wherein the particle size of said plurality of light diffusing particles is within a range of 0.1 μm to 10 μm.

4. The liquid silicone rubber composition according to claim 1, wherein the Shore A hardness is within a range of 30 to 60.

5. The liquid silicone rubber composition according to claim 1, wherein the light transmittance of said liquid silicone rubber composition is within a range of 85% to 90%.

6. An oral isolator manufactured of a liquid silicone rubber composition according to claim 1.

7. The oral isolator according to claim 6, wherein the liquid silicone rubber composition further comprising a plurality of light diffusing particles accounting for 0.2 wt % to 5.0 wt % of said liquid silicone rubber composition.

8. The oral isolator according to claim 7, wherein the particle size of said plurality of light diffusing particles is within a range of 0.1 μm to 10 μm.

9. The oral isolator according to claim 6, wherein the Shore A hardness of said liquid rubber composition is within a range of 30 to 60.

10. The oral isolator according to claim 6, wherein the light transmittance of said liquid silicone rubber composition is within a range of 85% to 90%.

11. The oral isolator according to claim 6, wherein the light transmittance of said oral isolator is within a range of 80% to 90% when the thickness of said oral isolator is 3.0 mm.

12. A method for manufacturing a liquid silicone rubber composition, comprising:
performing a preparation step to at least provide a first gel and a second gel, wherein said first gel comprises vinyl-terminated polydimethylsiloxane (PDMS) accounting for 30 wt % to 45 wt % of said first gel, silicon dioxide accounting for 25 wt % to 30 wt % of said first gel, and polymethylhydrogensiloxane accounting for 5 wt % to 25 wt % of said first gel, said second gel comprises vinyl-terminated polydimethylsiloxane accounting for 60 wt % to 70 wt % of said second gel, silicon dioxide accounting for 25 wt % to 30 wt % of said second gel and a catalyst accounting for 0.1 wt % to 1 wt % of said second gel;
performing a mixing step to mix said first gel and said second gel to form a mixed gel;
performing an introduction step to introduce said mixed gel into a mold; and
performing a curing step to heat up said mold to cure said mixed gel to form said liquid silicone rubber composition.

13. The method according to claim 12, wherein, in the curing step, the temperature of said mold is within a range of 140° C. to 170° C.

14. The method according to claim 12, wherein, in the preparation step, said first gel further comprises a light diffusing agent accounting for 0.1 wt % to 2.5 wt % of said first gel, and said second gel further comprises said light diffusing agent accounting for 0.1 wt % to 2.5 wt % of said second gel.

15. The method according to claim 14, wherein said light diffusing agent comprises a plurality of diffusing particles, the particle size of said plurality of light diffusing particles being within a range of 0.1 μm to 10 μm.
